(19) United States
(12) Patent Application Publication
(10) Pub. No.: US 2008/0303817 A1
(43) Pub. Date: Dec. 11, 2008

(54) Analyzing mesh generating apparatus

(75) Inventors: Ichiro Kataoka, Kudamatsu (JP); Ichiro Nishigaki, Ishioka (JP); Yoshimitsu Hiro, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Ltd

(21) Appl. No.: 12/155,800

(22) Filed: Jun. 10, 2008

(30) Foreign Application Priority Data
Jun. 11, 2007 (JP) 2007-154181

(51) Int. Cl. G06T 15/00

(52) U.S. Cl. 345/423

(57) ABSTRACT

An analyzing mesh generating apparatus has a model read unit for reading data, a required quality and shape data of an input hexahedral mesh model, a display unit for displaying said hexahedral mesh model, and a mesh element number reduction unit for reducing the number of mesh elements in the data. The analyzing mesh generating apparatus has also a mesh quality evaluation unit for evaluating a mesh quality regarding whether mesh element reduction is performed while maintaining the required quality data, and a mesh fine division unit for performing mesh fine division to change meshes to coarse/dense meshes, relative to the hexahedral mesh model with the reduced number of mesh elements in the data.

### BACKGROUND OF THE INVENTION

1. Field of the Invention

The present invention relates to an analyzing mesh generating apparatus for generating meshes to analyze an object shape.

2. Description of Related Art

For example, as a mesh generating technique, a method is known which automatically generates a fluid structural lattice (refer to JP-A-2002-318823). This method numerically analyzes one or a plurality of shape models placed in a flow field.

Namely, an orthogonal space calculation lattice is set to an analysis target flow field, a virtual object model is defined by using a portion of the orthogonal space calculation lattice, and deformed being aligned with the border of a shape model to form a lattice. The virtual object model is deformed by sliding lattice points of the orthogonal space calculation lattice on a border of the shape model and optimizing energy and Jacobian as a multi objective function.

An analyzing model generating method is proposed (refer to JP-A-2003-132099). With this method, an analyzing target shape model is input and compared with at least one already generated shape model stored in a memory, and in accordance with the comparison result, at least one analysis model corresponding to the analyzing target shape model is formed by utilizing analysis model forming information stored in the memory in correspondence with the already generated shape model.

A hexahedral mesh generating method is proposed (refer to JP-A-2006-201857). With this method, a layout of an interior surface of a cubic body is formed inside the cubic body by using, as a border, quadrilateral meshes each constituted of an even number of quadrilateral elements and covering the surface of the cubic body, and a cross point of three interior surfaces in the layout is converted into a hexahedral element.

In generating a hexahedral mesh, a simple interior surface is generated by referring to identity of a self-intersecting point type, and non-regular hexahedral meshes are generated by forming the interior surface including a simple interior surface.

### SUMMARY OF THE INVENTION

The mesh generating technique described in JP-A-2002-318823 is the technique of generating a lattice automatically without man power when analyzing a structural body having a complicated shape and a nearby flow field. With this technique, meshes are optimized by deforming a shape while maintaining the quality of the meshes by confirming Jacobian. Yacobian is parameters to be used for physical quantity conversion between calculation coordinates and physical coordinates of a virtual object model.

With this method, however, although meshes are modified while considering an element quality, there is no approach to efficient calculations. Namely, there are not provided a function of reducing meshes not directly related to analysis, a function of reducing meshes in accordance with a requested mesh quality and a function of finely dividing meshes.

Further, if a model has a complicated shape, it is necessary to generate hexahedral meshes having a number of elements corresponding to the complicated shape. Efficient calculations are therefore impossible. Furthermore, a load on a mesh editing work increases, the work being executed to reduce the number of elements and generate a mesh model having a good quality and a small number of elements.

The mesh generating technique described in JP-A-2002-318823 is therefore associated with an inconvenience that it takes a time to generate and analyze meshes if the number of meshes is large.

The mesh generating technique described in JP-A-2003-132099 is associated with an inconvenience that since an analyzing target shape model is used as a template, it is not possible to generate meshes corresponding to a characteristic shape such as shapes of steps, projections, holes and grooves.

The mesh generating technique described in JP-A-2006-201857 is associated with an inconvenience that since identity of a self-intersecting point type is judged, it is not possible to generate meshes corresponding to a characteristic shape such as shapes of steps, projections, holes and grooves.

An object of the present invention is therefore to provide an analyzing mesh generating apparatus capable of shortening the time required for mesh generation and analysis even if there are a number of meshes, and generating meshes corresponding to a characteristic shape such as shapes of steps, projections, holes and grooves.

An analyzing mesh generating apparatus has a model read unit for reading data, a required quality and shape data of an input hexahedral mesh model, a display unit for displaying said hexahedral mesh model, and a mesh element number reduction unit for reducing the number of mesh elements in the data.

The analyzing mesh generating apparatus has also a mesh quality evaluation unit for evaluating a mesh quality regarding whether mesh element reduction is performed while maintaining the required quality data, and a mesh fine division unit for performing mesh fine division to change meshes to coarse/dense meshes, relative to the hexahedral mesh model with the reduced number of mesh elements in the data.

According to the present invention, in order to calculate efficiently, an analyzing hexahedral mesh model of a good quality is generated for a complicated shape mode. Namely, a low density mesh model with a reduced number of mesh elements is generated while maintaining quality, and coarse/dense mesh elements are given to the low density mesh model.

Nodes shared by a mesh element and adjacent element of a hexahedral mesh model are moved to merge and remove mesh elements. In this case, element reduction is repeated by changing a reduction order of each mesh element and changing each node merge position, while evaluating an element size of a mesh element, continuity of meshes and required quality.

For the characteristic shape such as shapes of ribs, bosses, holes and grooves, whether mesh elements corresponding to the shape are to be removed during mesh element reduction is interactively designated.

For a hexahedral mesh model requiring a time to analyze, mesh elements are reduced to the extent that the coarse/dense work can be made, in the coarse/dense edit work for mesh elements. After mesh elements are reduced, the mesh coarse/dense work is made to generate a mesh model allowing efficient calculation.

According to the present invention, since efficient calculations are performed, hexahedral meshes having a good quality and complicated shape can be generated through element reduction. Accordingly, even if there are a number of meshes, it is advantageous in that the time required for mesh generation and analysis can be shortened.

Further, interactive designation is incorporated for whether meshes corresponding to a characteristic shape such as shapes of ribs, bosses, holes and grooves are to be removed during element reduction. Since an element reduction or fine division operation can be performed with a simple operation, it is advantageous in that a manual load on mesh modification can be mitigated.

### BRIEF DESCRIPTION OF THE DRAWINGS

FIG. 1 is a diagram showing the system configuration of an analyzing mesh generating apparatus according to an embodiment of the present invention.

FIG. 2 is a data flow chart of the analyzing mesh generating apparatus.

FIG. 3 is a flow chart illustrating specific processes to be executed by the analyzing mesh generating apparatus.

FIGS. 4A and 4B are diagrams illustrating a mesh reduction process, FIG. 4A is a diagram before mesh reduction, and FIG. 4B is a diagram after mesh reduction.

A, B and C in FIG. 5 are diagrams showing directions of merging already existing nodes in mesh reduction, A in FIG. 5 shows a state before merging, B in FIG. 5 shows a state of vertical merging of a central row after horizontal merging of a central column, and C in FIG. 5 shows a state of horizontal merging of a central column after vertical merging of a central row.

FIG. 6 is a diagram illustrating a change in an element reduction direction by insertion of a junction mesh, A in FIG. 6 shows a state before insertion of a junction mesh, B in FIG. 6 shows a state after insertion of a junction mesh, C in FIG. 6 shows a change after insertion of the junction mesh, D in FIG. 6 shows a state after insertion of another a junction mesh, and E in FIG. 6 shows a change after insertion of the other junction mesh.

FIGS. 7A to 7C are diagrams illustrating a mesh reduction designating method based on a shape, FIG. 7A shows a state before reduction, FIG. 7B illustrates element reduction including a projection shape, and FIG. 7C illustrates element reduction other than a projection shape.

FIGS. 8A and 8B are diagrams illustrating mesh fine division based on a shape, FIG. 8A shows a state before fine division, and FIG. 8B shows a state after fine division.

FIG. 9 is a diagram showing an operation screen for mesh element reduction—fine division and change to coarse/dense meshes.

FIG. 10 is a diagram showing a screen displaying a reduced mesh model.

FIG. 11 is a diagram showing a screen for an edit operation.

FIG. 12 is a diagram showing a screen after a reduction process of removing all elements displayed in an emphasized state.

FIG. 13 is a diagram showing a screen on which an edit work of changing meshes of an element reduced model to coarse/dense meshes.

FIG. 14 is a diagram showing a screen illustrating a mesh edit work.

FIG. 15 is a diagram showing a screen for obtaining a mesh fine division area when a fine division button is depressed.

FIG. 16 is a diagram showing a screen indicating a model with coarse/dense meshes.

FIG. 17 is a diagram showing a screen indicating a model with coarse/dense meshes.

### DESCRIPTION OF THE EMBODIMENT

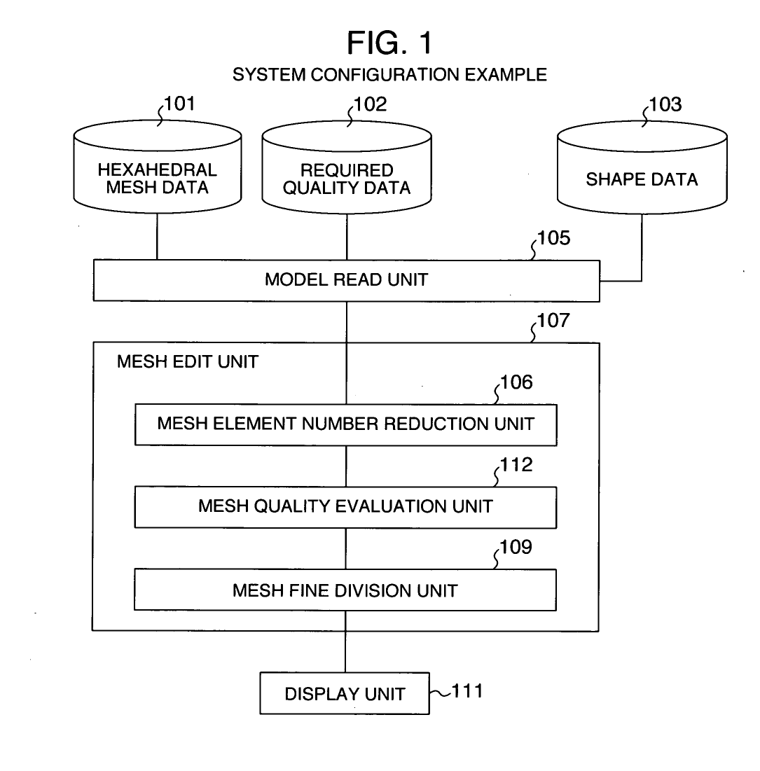

An embodiment of the present invention will now be described with reference to FIGS. 1 to 17.

FIG. 1 is a diagram showing the system configuration of an analyzing mesh generating apparatus. In FIG. 1, input data includes hexahedral mesh data 101, required quality data 102, and shape data 103.

The hexahedral mesh data 101 represents a hexahedral mesh model. The required quality data 102 is data regarding a mesh element size and a required target quality. The element size is for example 2.0 mm and set to designate element division. The required target quality includes an interior angle and stretch of each mesh element. The shape data 103 represents a shape as a base of mesh data.

The hexahedral mesh data 101, required quality data 102 and shape data 103 may be input directly or input via a storage medium.

A model read unit 105 reads the hexahedral mesh data 101, required quality data 102 and shape data 103. Thereafter, a mesh edit unit 107 performs element reduction while evaluating the required quality, and performs mesh fine division to change meshes to coarse/dense meshes, relative to the mesh model constituted of the hexahedral mesh data 101.

Namely, a mesh element number reduction unit 106 reduces the number of mesh elements from a whole generated mesh model to simplify the model so as to allow a model edit work to change meshes to coarse/dense meshes. In order to reduce the number of mesh elements, a shared element plane of adjacent elements of hexahedral meshes is joined, and the adjacent elements are also simplified while maintaining continuity of meshes.

A mesh quality evaluation unit 112 evaluates whether a mesh model obtained by reducing the number of mesh elements to such a degree that the generated mesh model can be edited, and has simplified meshes maintaining the required quality, i.e., has the required element number.

A mesh fine division unit 109 performs mesh fine division to change meshes to coarse/dense meshes, relative to the hexahedral mesh model with a reduced number of mesh elements. A display unit 111 displays a finely divided mesh model.

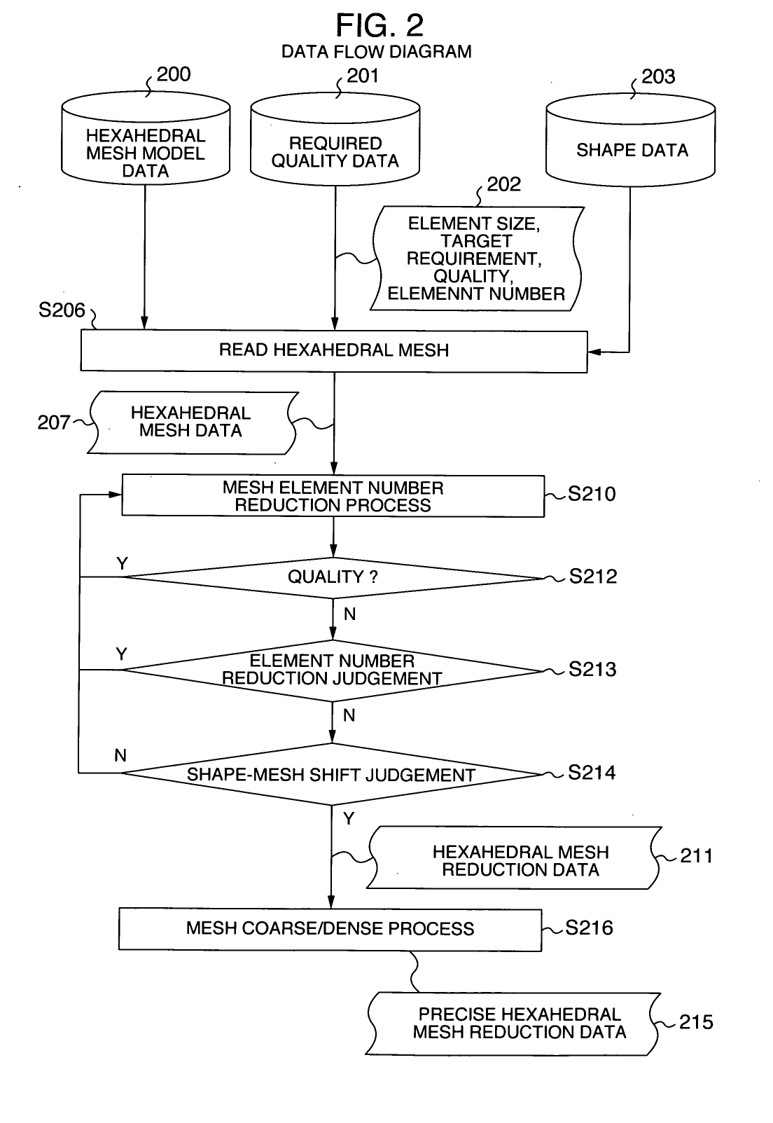

FIG. 2 is a data flow diagram of the analyzing mesh generating apparatus. FIG. 2 shows a flow of data during a mesh model edit work of reducing mesh elements of a mesh model and changing meshes to coarse/dense meshes.

Referring to FIG. 2, the model read unit 105 reads hexahedral mesh model data 200, required quality data 201 and shape data 203 (Step S206). The required quality data 201 contains a mesh element size, a required target quality and the number of mesh elements 202.

The mesh element number reduction unit 106 executes an element number reduction process for the mesh model constituted of the hexahedral mesh data 207 read at Step S206 (Step 210). In this case, the mesh quality evaluation unit 112 judges whether elements after the reduction process maintains the quality (Step S212).

Namely, for the elements maintaining the quality such as interior angle and stretch of the hexahedral mesh data at Step S212, the mesh element number reduction unit 106 deletes adjacent mesh elements of hexahedral meshes at Step S210 while maintaining the required element size.

If elements do not maintain the required quality at Step S212, the mesh quality evaluation unit 112 judges whether the elements after the reduction process satisfy the required element number (Step S213). If the required quality is not satisfied at Step S212 and the required element number is not satisfied at Step S213, mesh elements are not reduced at Step S210.

If the required element number is not satisfied at Step S213, the mesh element number reduction unit 106 judges whether there is a shift between a shape and mesh elements (Step S214).

If there is a shift between a shape and mesh elements at Step S216, mesh elements are not reduced at Step S210.

If there is a shift between a shape and mesh element at Step S214, the mesh fine division unit 109 executes a mesh coarse/dense process in accordance with hexahedral mesh reduction data 211 (Step S216).

In the mesh coarse/dense process at Step S216, mesh simplification—fine division is performed relative to a coarse/dense designation area designated by a user. Precise hexahedral mesh reduction data 215 can therefore be obtained.

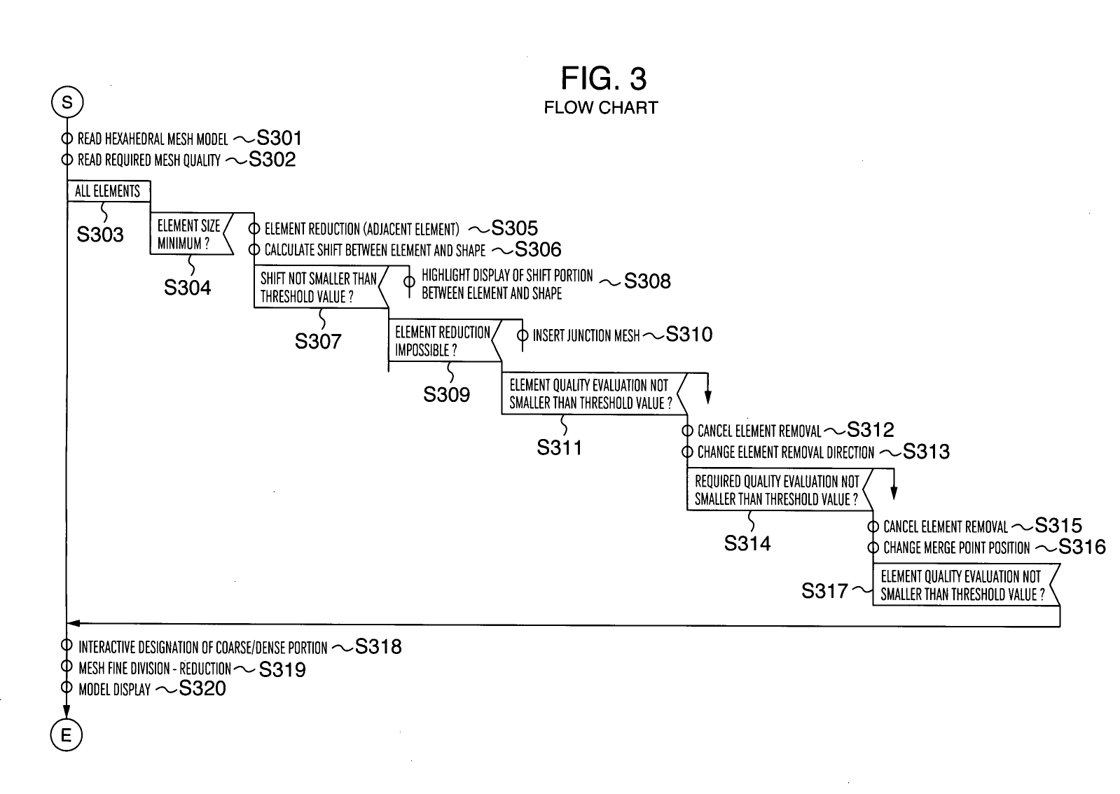

FIG. 3 is a flow chart illustrating specific processes to be executed by the analyzing mesh generating apparatus. FIG. 3 illustrates processes to be executed by the model read unit 105, and the mesh element number reduction unit 106, mesh quality evaluation unit 112 and mesh fine division unit 109, respectively of the mesh edit unit 107.

Referring to FIG. 3, the model read unit 105 reads first the hexahedral mesh model (Step S301), and reads next the required element size, the required quality data and shape data (Step S302).

The mesh element number reduction unit 106 acquires the hexahedral mesh model of all elements, the required element size, the required quality data and the shape data (Step S303).

The mesh element number reduction unit 106 judges (Step S304) whether the element size of each of all elements (Step S303) of the hexahedral mesh model is minimum.

The mesh element number reduction unit 106 executes (Step S305) an element reduction process sequentially starting from an element having a minimum element size (Step S304). The element reduction process is a process of removing a target element by node merge and junction mesh insertion relative to elements adjacent to the target element.

In the element reduction process, the mesh element number reduction unit 106 calculates a shift between a model constituted of element sides of the mesh model and a shape model (Step S306).

The mesh element number reduction unit 106 judges whether a shift between the model constituted of elements sides of the mesh model and the shape model is not smaller than a threshold value (Step S307).

If the shift is not smaller than the threshold value (Step S307), the mesh element number reduction unit 106 displays an element having a shift from a shape on the screen of the display unit in a highlight state (Step S308). If a shift between the shape and a mesh is smaller than the threshold value (Step S307), the mesh quality evaluation unit 112 evaluates whether the number of meshes after element reduction satisfies the required element number (Step S309).

In the mesh evaluation by the mesh quality evaluation unit 112, when an element and adjacent elements are reduced, there is a case in which element reduction is difficult or a case in which an element is distorted. To avoid this, the mesh element number reduction unit 106 inserts a junction mesh in the midst of element reduction to change an element reduction direction so that the mesh element number reduction unit 106 can reduce elements (Step S310).

After mesh elements are reduced by the mesh element number reduction unit 106, the mesh quality evaluation unit 112 judges whether the element quality is better than the required quality (Step S311). An element interior angle and an element stretch are used for the element quality evaluation. The element interior angle is an angle between element sides, and the element stretch is a ratio of a shortest element side to a longest element side.

If there exists an element not satisfying the required element quality, the mesh element number reduction unit 106 cancels once the element reduction (Step S312), and changes an element removal direction to again perform the element reduction (Step S313).

After the mesh element number reduction unit 106 performs again the element reduction, the mesh quality evaluation unit 112 evaluates an element quality. If a threshold value is not satisfied (Step S314), the mesh element number reduction unit 106 performs again the element deletion, and changes a position of a point where an element is merged (deleted) to perform again the element reduction (Steps S315 and S316).

After the mesh element number reduction unit 106 performs the element reduction, the mesh fine division unit 109 processes to change meshes to coarse/dense meshes through interactive operations (Step S318). The mesh fine division unit 109 executes an interactive designation process of designating a coarse/dense mesh portion to finely divide and reduce meshes (Step S319). The mesh fine division unit 109 can therefore generate an analyzing mesh model of good quality and display the result (Step S320).

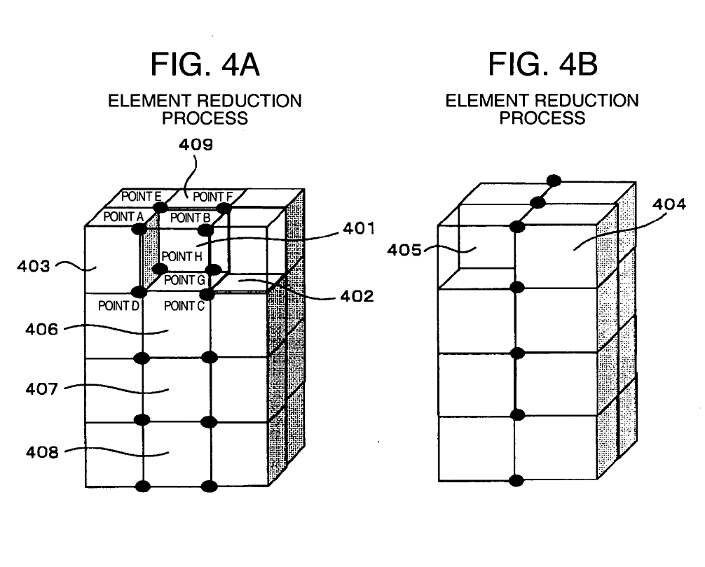

FIGS. 4A and 4B are diagrams illustrating a mesh reduction process, FIG. 4A shows a state before the mesh reduction, and FIG. 4B shows a state after the mesh reduction.

Referring to FIGS. 4A and 4B, the mesh element number reduction unit 106 refers to an element 401 and adjacent elements 402 and 403, and interconnects points A and B, points C and D, points E and F and points H and G of the element 401 existing on the shape plane shown in FIG. 4A.

In this manner, the mesh element number reduction unit 106 deletes the element 401 shown in FIG. 4A and generates elements 404 and 405 shown in FIG. 4B.

In the order of element reduction, after the element existing on the shape plane is used as a reduction target, the mesh element number reduction unit 106 reduces meshes in the volume of the same vertical column as that of the element 401 while maintaining continuity of meshes.

After the element sides of the planes adjacent to the element 401 are deleted, the mesh element number reduction unit 106 deletes nearby elements 406, 407, 408 and 409 to reduce elements, while maintaining continuity of meshes.

Evaluation of an element quality is judged based on the following formulas (1) to (3):

Elemsize>Min(AB, CD, EF,HG, . . . ) (1)

Ang_threshold>Max(∠BAC, ∠BAE, ∠AE, . . . ) (2)

Stretch_threshold>Max(AB, CD, EF, HG, . . . )/Min(AB, CD, EF, HG, . . . ) (3)

The formula (1) indicates that a required element size (Elemsize) is compared with a reduction target element size, and if an element has a size smaller than the required element size, this element is used as a reduction target. The formula (2) indicates that if an interior angle (Ang_threshold) of a required quality is larger than an element interior angle of the reduction target, this reduction target is used as the element to be reduced. The interior angle is an angle between nodes of the hexahedral mesh.

The formula (3) indicates that if a required quality (Stretch_threshold) of a stretch is larger than a ratio of a shortest side to a longest side of a reduction target element, the element reduction is not performed. The stretch is a ratio of the shortest side to the longest side of a hexahedral mesh.

Basing upon the formulas (1) to (3), the mesh element number reduction unit 106 reduces elements, and thereafter compares again the elements after element deletion, and if the required quality is not satisfied, the element reduction is not performed to be left as initial elements.

FIG. 5 is a diagram showing directions of merging an already existing node in mesh reduction. A in FIG. 5 shows a state before merging, B in FIG. 5 shows a state of vertical merging of a central row after horizontal merging of a central column, and C in FIG. 5 shows a state of horizontal merging of a central column after vertical merging of a central row.

With an example of the merging direction shown at B in FIG. 5, the mesh element number reduction unit 106 designates a horizontal direction as a merge destination of shared nodes B, D and F of elements ABCD 501, CDEF 502, BGDH 503 and DHFI 504 shown at A in FIG. 5, and thereafter the shared nodes are moved in the vertical direction.

When the element ABCD 501 is to be reduced, the mesh element number reduction unit 106 regards the element BGDH 503 sharing the element ABCD 501 as an adjacent element, and executes a merge process for the shared nodes B and D of the element BGDH 503.

The motion destinations of the points B and D are the points G and H. The mesh element number reduction unit 106 moves the points B and D to form an element AGCH 505 shown at B in FIG. 5. Similarly, for the element CDEG 502, the mesh element number reduction unit 106 merges shared nodes D and F of an adjacent element DHFI 504 into the points H and I to form an element CHIE 506 at B in FIG. 5. Next, the mesh element number reduction unit 106 merges the shared nodes C and H of the elements AGCH and CHIE into the points E and I to form an element AGIE 507.

With an example of the merging direction shown at C in FIG. 5, the mesh element number reduction unit 106 designates a vertical direction as a merge destination of shared nodes C, D and H of the elements ABCD 501, CDEF 502, BGDH 503 and DHFI 504 shown at A in FIG. 5, and thereafter the shared nodes are moved in the horizontal direction.

The mesh element number reduction unit 106 merges the shared nodes C, D and H of the adjacent elements CDEF 502 and DHFI 504 of the elements ABCD 501 and BGDH 503 into the points E, F and I to reduce the elements to elements ABEF 508 and DHFI 509. Next, the mesh element number reduction unit 106 merges the shared nodes B and F of the elements ABEF 508 and BGFI 509 into the points G and I to form an element AGEI 510 at C in FIG. 5.

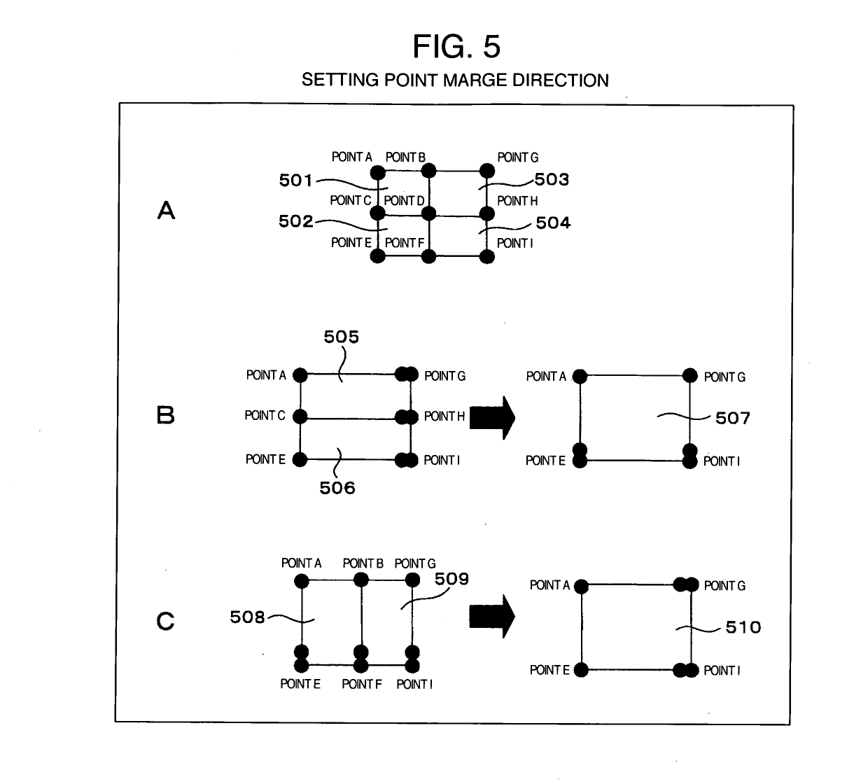

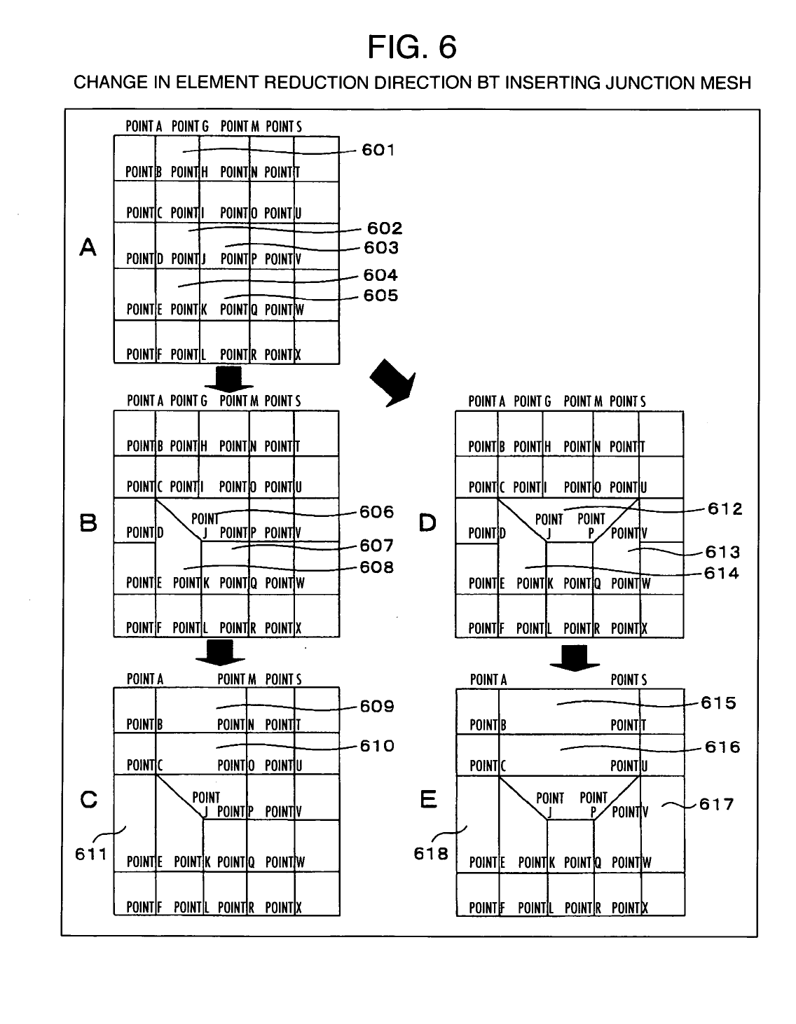

FIG. 6 is a diagram illustrating a change in an element reduction direction by insertion of a junction mesh, A in FIG. 6 shows a state before insertion of a junction mesh, B in FIG. 6 shows a state after insertion of a junction mesh, C in FIG. 6 shows a change after insertion of the junction mesh, D in FIG. 6 shows a state after insertion of another a junction mesh, and E in FIG. 6 shows a change after insertion of the other junction mesh.

A to E in FIG. 6 show an example of a process of changing an element reduction direction by inserting a junction mesh.

The mesh element number reduction unit 106 reduces an element AGHB 601 shown at A in FIG. 6 by moving and merging shared nodes G and H with an adjacent element GMNH. After the element is reduced, the mesh element number reduction unit 106 performs this operation for adjacent elements BHIC and HNOI, similarly for adjacent elements CIJD 602 and IOPJ 603 and for adjacent elements DJKE 604 and JPQK 605, in order to maintain continuity of meshes.

In this case, however, if an element division number is fixed at points F, L and R and elements cannot be changed, it is necessary to leave elements EKLF and KQRL without reducing them. In this case, the mesh element number reduction unit 106 replaces the elements JPQK 605 and DJKE 604 adjacent to the elements EKLF and KQRL, and further the adjacent elements CIJD 602 and IOPJ 603 with a junction mesh shown at D in FIG. 6.

The junction mesh is constituted of elements 606, 607 and 608 including nodes C, 0, Q and E, and the mesh element number reduction unit 106 reduces adjacent elements while maintaining the junction mesh. As a result of reduction, the mesh element number reduction unit 106 generates elements AMBN 609, BNCO 610 and an element 611 shown at C in FIG. 6 to thus repeat the element reduction by changing the element reduction direction.

As shown at D in FIG. 6, if the element division number at points F, L, R and X is fixed, without reducing the elements of two columns shown at B and C in FIG. 6, the mesh element number reduction unit 106 replaces the elements CIDJ 602, IOJP 603, OUPV, DJKE 604, JPQK 605 and PVQW with a junction mesh (elements 612, 613 and 614). The mesh element number reduction unit 106 reduces elements of three columns in the vertical direction to generate elements 615 and 616 and reduces elements of two columns in right and left vertical directions to generate elements 617 and 618.

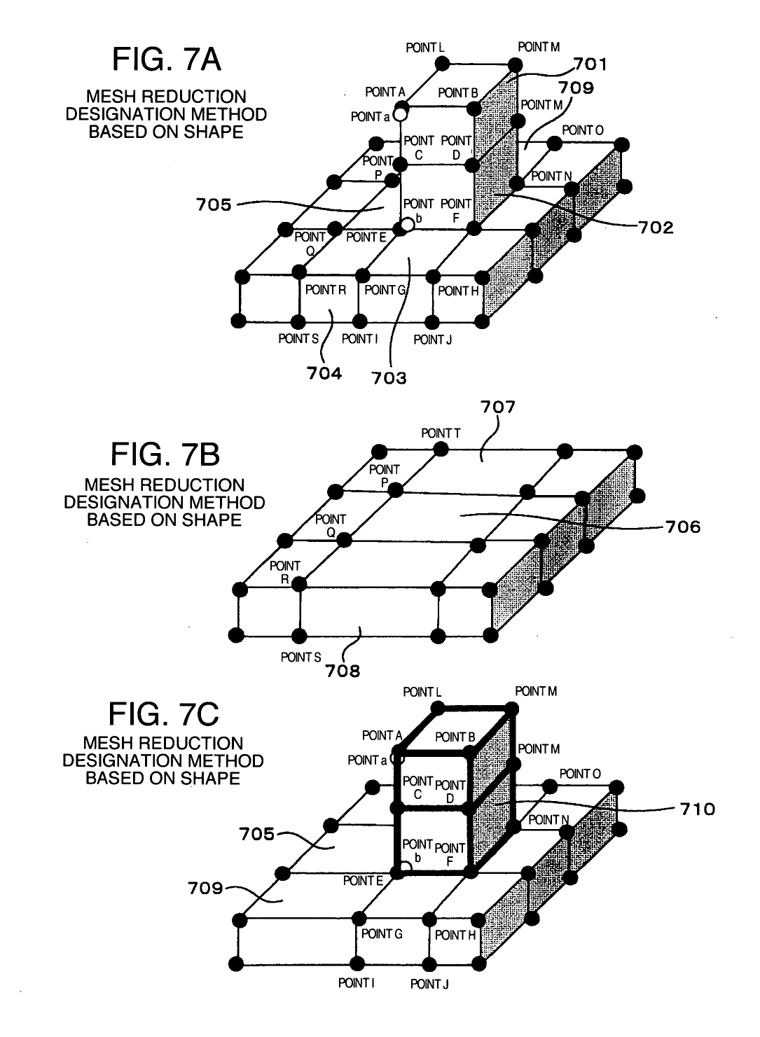

FIGS. 7A to 7C are diagrams illustrating a mesh reduction designation method based on a shape, FIG. 7A shows a state before reduction, FIG. 7B illustrates element reduction including a projection shape, and FIG. 7C illustrates element reduction other than a projection shape.

The mesh element number reduction unit 106 repeats element reduction for element 701 and 702 shown in FIG. 7A to reduce the elements ABMLCDM 701 and CDMNFET 702 including a projection shape in the vertical direction.

In this case, the mesh element number reduction unit 106 reduces elements 704 and 709 adjacent to the elements 701 and 702 shown in FIG. 7A. The mesh element number reduction unit 106 moves and merges the element 701 and 702 into nodes T, P, Q, R and S shown in FIG. 7B so that the elements 701 and 702 including the projection shape are simplified to elements 706, 707 and 708 to remove the elements forming the projection shape.

If the elements 701 and 702 forming the projection shape are to be removed as shown in FIG. 7B, the mesh element number reduction unit 106 displays the elements on the screen of the display unit 111 in a highlight state to indicate that the elements 701 and 702 corresponding the projection shape are removed by element reduction.

Whether the projection shape is distinguished by element reduction depends on a case in which the mesh elements are larger than the shape or on a case meshes in conformity with the shape are deleted. From this reason, the mesh element number reduction unit 106 calculates a shift between a mesh position and a shape to be caused by the element reduction, from the following formulas ((4) and (5). If the shift is not smaller than a threshold value, meshes are not reduced, but the elements 701 and 702 corresponding to the projection shape are displayed on the screen of the display unit 111 in a highlight state.

Threshold<|Vertex_{—}a−vertex_{—}e|−|Node_{—}a−Vertec_{—}a (4)

Node_{—}a=min(Vertex_{—}a) (5) nearest node

For example, the mesh element number reduction unit 106 searches a node shown in FIG. 7B nearest to a shape point a contained in the element 701. If a distance between the shape point and node is not shorter than a threshold value after the element reduction, meshes are not reduced as shown in FIG. 7C. Similarly, a node shown in FIG. 7B nearest to another shape point b is searched. If a distance between the shape point and node is not shorter than the threshold value after the element reduction, meshes are not reduced as shown in FIG. 7C.

In order not to reduce the elements 701 and 702 corresponding the projection shape, the mesh element number reduction unit 106 reduces elements adjacent to nodes T, P, Q, R and S shown in FIG. 7B as shown in FIG. 7C to generate elements 705 and 709. In this manner, it becomes possible to change the characteristic shape such as shapes of ribs, bosses, holes and fillets by an interactive process.

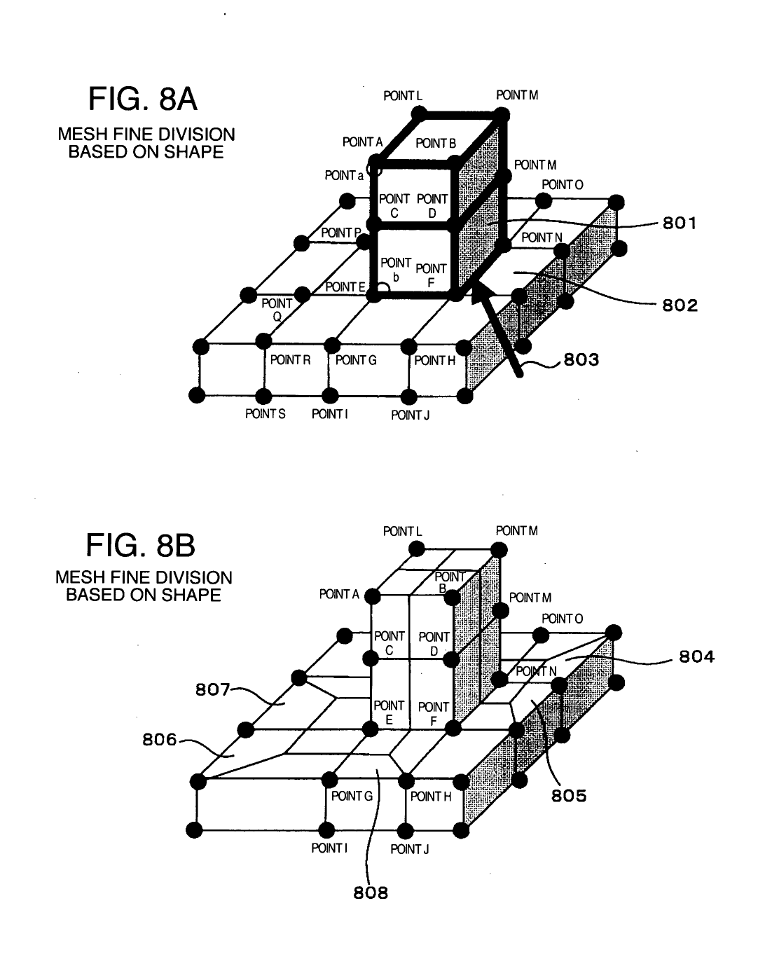

FIGS. 8A and 8B are diagrams illustrating mesh fine division based on a shape, FIG. 8A shows a state before fine division, and FIG. 8B shows a state after fine division. FIGS. 8A and 8B illustrate an example of an interactive operation for the element reduction regarding a projection shape.

In reducing the elements of a projection shape shown in FIG. 8A to a target element size, the mesh element number reduction unit 106 displays elements having a shift from the shape not smaller than a threshold value on the screen of the display unit 111 in a highlight state to inquire a user about whether the elements are to be reduced (elements 801 and 802). If the user wishes to leave an element, a target element is selected with a mouse pick 803 or the like.

For the element designated with the mouth pick 803 shown in FIG. 8A, the mesh fine division unit 109 inserts junction elements 804, 805, 806 and 807 to finely divide the meshes without simplifying the elements, as shown in FIG. 8B.

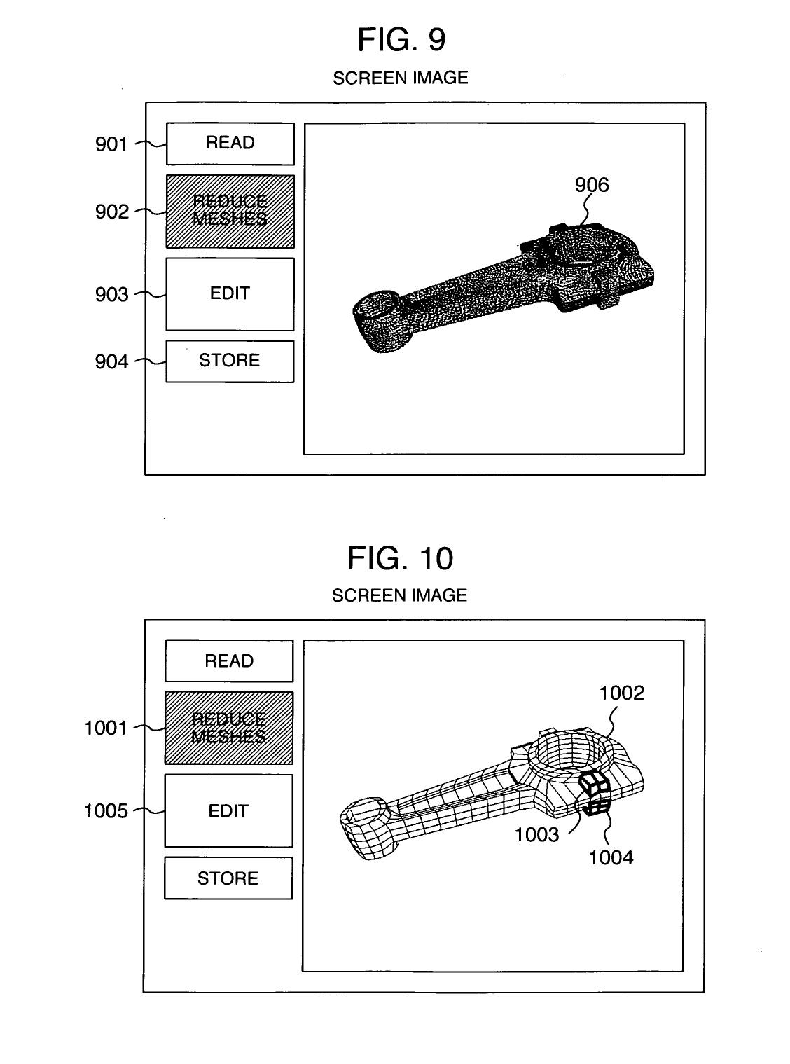

FIGS. 9 to 17 show screens of the display unit 111 of the mesh edit unit 107.

FIG. 9 is a diagram showing an operation screen for mesh element reduction—fine division and change to coarse/dense meshes.

Referring to FIG. 9, as a user depresses a read button 901 on the screen of the display unit 111, the mesh edit unit 107 reads hexahedral mesh model data 906, and displays the model on the screen of the display unit 111.

As the user depresses a mesh reduction button 902 for the mesh model, the mesh element number reduction unit 106 reduces elements of the mesh entirety while retaining the required element number and required quality. As the user depresses an edit button 903, the mesh edit unit 107 performs an edit work to give coarse/dense meshes to the reduced mesh entirety. As the user depresses a store button 904, the mesh edit unit 107 stores the generated mesh model.

FIG. 10 shows an example of a screen showing a reduced mesh model result.

Referring to FIG. 10, as the user depresses a mesh element reduction button 1001 on the screen of the display unit 111, relative to a reduced mesh model 1002, the mesh element number reduction unit 111 further performs the element reduction.

In this case, during the element reduction, if a shift between elements and the characteristic shape such as shapes of projections, holes, steps and grooves of a shape model, the mesh element number reduction unit 106 displays elements which may have a shift from the shape, on the screen of the display unit 111 in an emphasized manner (1003 and 1004). If the user depresses an edit button 1005, the mesh element number reduction unit 106 makes the screen transit to a screen with which an element is interactively designated so as to leave the element without reducing it.

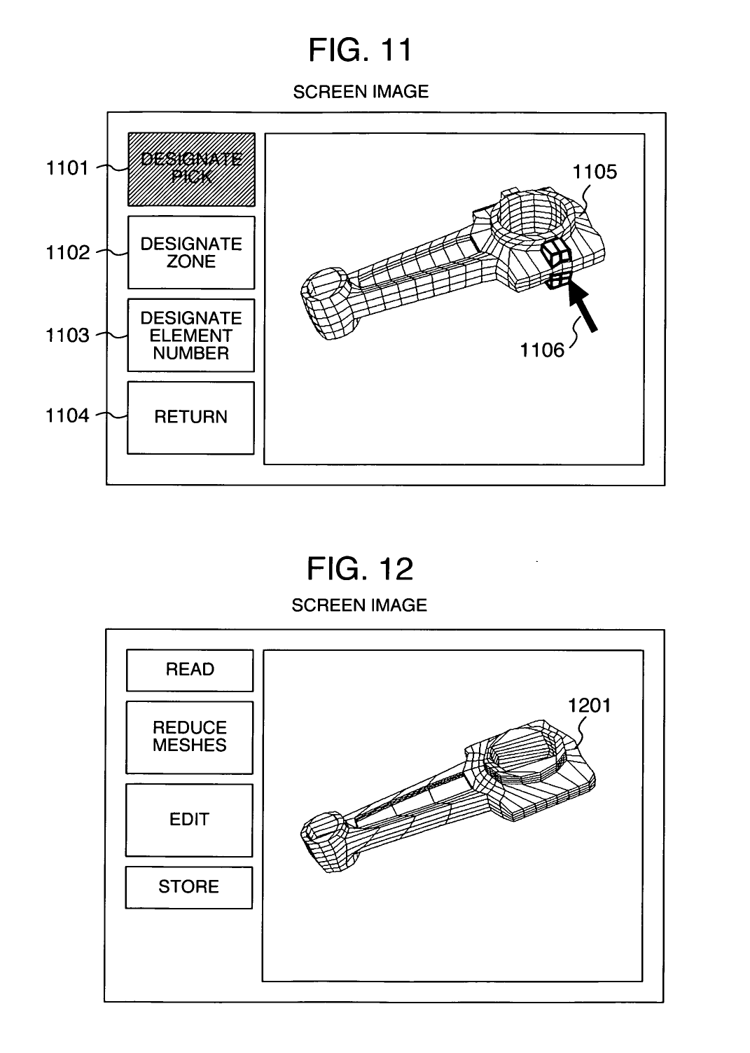

FIG. 11 shows an example of a screen during an edit operation.

Referring to FIG. 11, as the user depresses a pick designation button 1101 on the screen of the display unit 111, relative to a mesh model 1105 and designates an element not to be reduced with a mouse cursor 1106, the mesh element number reduction unit 106 simplifies elements while leaving the elements corresponding to the projection shape.

FIG. 12 shows an example of a reduction process executed without leaving the elements displayed in an emphasize manner in FIG. 10.

Referring to FIG. 12, if the user intends not to leave the elements displayed in an emphasized manner which elements may have a shift from the shape, the mesh element number reduction unit 106 reduces the elements to the target element size so that the element corresponding to the projection shape are deleted as shown at 1201.

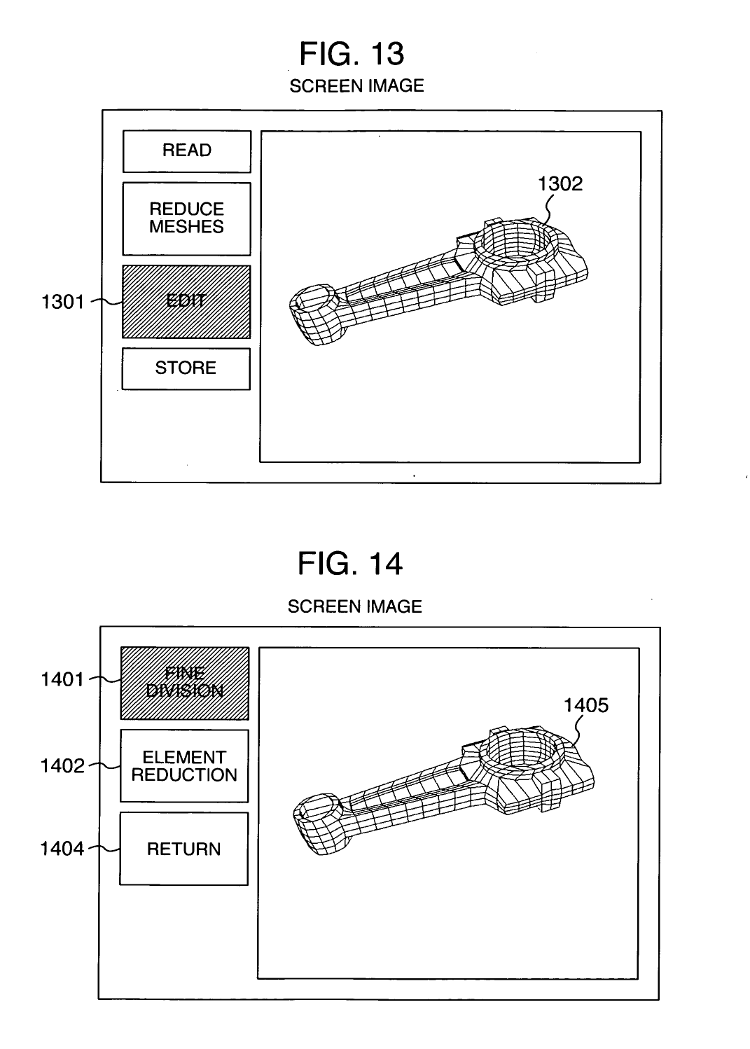

FIG. 13 shows a screen to be used for performing an edit work of giving coarse/dense meshes to an element reduced model.

Referring to FIG. 13, as the user depresses an edit button 1301 on the screen of the display unit 111, relative to a mesh model 1302, the mesh element number reduction unit 106 makes the screen transit a screen to be used for interactively designating an element to which coarse/dense meshes are given.

FIG. 14 shows an example of a screen illustrating a mesh edit work state.

Referring to FIG. 14, as the user depresses a fine division button 1401 on the screen of the display unit 111, the mesh fine division unit 109 generates partially dense meshes for a target mesh model 1405. As the user depresses an element reduction button on the screen of the display unit 111, the mesh fine division unit 109 generates partially coarse meshes for the mesh model. After editing the mesh model, as the user depresses a return button 1404, the screen returns to the original screen from the edit screen.

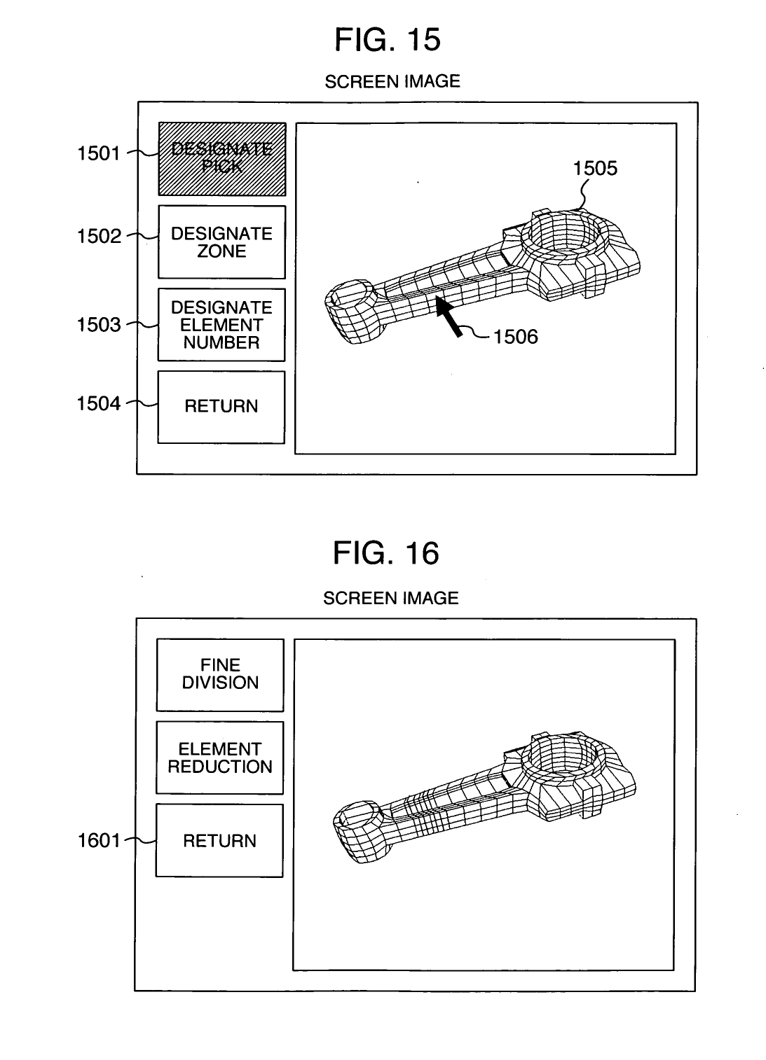

FIG. 15 shows an example of a screen to be used for obtaining a mesh fine division area when the fine division button 1401 is depressed.

As a method of designating an element to which coarse/dense meshes are given, by the user on the screen of the display unit 111, there are element pick designation 1501 with a mouth, zone designation 1502 for designation by surrounding an area with a mouth, and input designation 1503 for inputting an element serial number of each mesh. Referring to FIG. 15, dense meshes can be designated as the user depresses the pick designation 1501 on the screen of the display unit 111, places a mouth cursor 1505 on the mesh element of a mesh model 1505 and clicks the mouth cursor.

In this manner, the mesh fine division unit 109 makes fine the element size of a mesh to perform mesh fine division. In this case, the mesh fine division unit 109 forms a node at the center of each element side and couples nodes with a line to perform fine division. As the user depresses a return button 1504 on the screen of the display unit 111, the screen returns to the original screen from the edit screen.

FIG. 16 shows an example of a screen showing a model with coarse/dense meshed.

Referring to FIG. 16, as the user depresses a return button 1601 on the screen of the display unit 111, the mesh edit unit 107 returns to the original state from the mesh edit state.

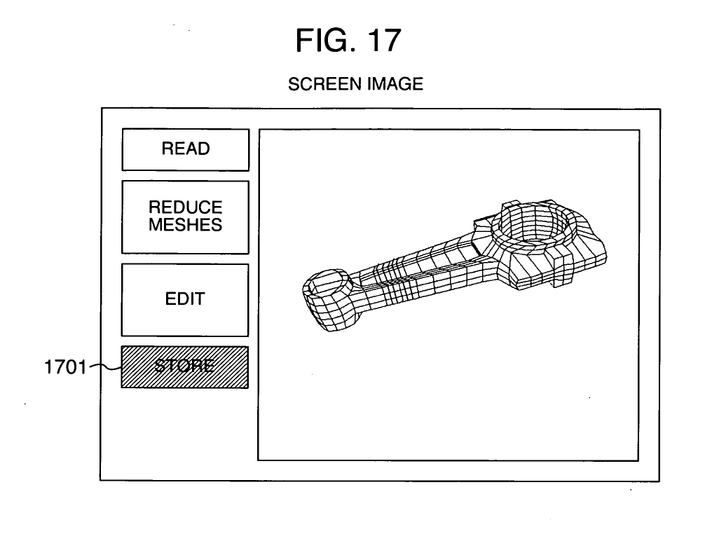

FIG. 17 shows an example of a screen displaying a coarse/dense model.

Referring to FIG. 17, as the user depresses a store button 1701 on the screen of the display unit 111, the mesh edit unit 107 stores the mesh model.

The present invention is not limited to the above-described embodiment, but it is obvious that the embodiment may be modified in various ways without departing from the gist of the present invention.

1. An analyzing mesh generating apparatus comprising:
a model read unit for reading data, required quality data and shape data of an input hexahedral mesh model;
a display unit for displaying said hexahedral mesh model;
a mesh element number reduction unit for reducing the number of mesh elements in said data;
a mesh quality evaluation unit for evaluating a mesh quality regarding whether mesh element reduction is performed while maintaining the required quality data; and
a mesh fine division unit for performing mesh fine division to change meshes to coarse/dense meshes, relative to said hexahedral mesh model with the reduced number of mesh elements in said data.

2. The analyzing mesh generating apparatus according to claim 1, wherein said mesh quality evaluation unit evaluates the number of mesh elements and an element quality, and said mesh element number reduction unit reduces the number of mesh elements while maintaining the element quality evaluated by said mesh quality evaluation unit.

3. The analyzing mesh generating apparatus according to claim 1, wherein when said hexahedral mesh model having a large number of mesh elements is edited by changing high density meshes to coarse/dense meshes, said mesh fine division unit generates a mesh model with a reduced number of mesh elements and edits the low resolution mesh model to change low resolution meshes to coarse/dense meshes.

4. The analyzing mesh generating apparatus according to claim 1, wherein when said mesh elements are reduced, said mesh element number reduction unit inserts a junction mesh for coupling adjacent mesh elements, and changes a mesh element reduction direction while maintaining continuity of the adjacent mesh elements.

5. The analyzing mesh generating apparatus according to claim 1, wherein for a characteristic shape including shapes of steps, projections, holes and grooves, said mesh element number reduction unit checks a shift between said mesh elements and said characteristic shape with a reduced number of mesh elements, displays on said display unit a message of whether said mesh elements of said characteristic shape are to be reduced, and thereafter performs an operation including reduction of said mesh elements of said characteristic shape after a predetermined input is made to said message.

6. The analyzing mesh generating apparatus according to claim 5, wherein said mesh element number reduction unit reduces said mesh elements in accordance with a target mesh element size required basing upon said required quality data.

7. The analyzing mesh generating apparatus according to claim 5, wherein said mesh element number reduction unit displays on said display unit an alert image of mesh elements having a large shift from said characteristic shape caused by reduction of said mesh elements.

8. The analyzing mesh generating apparatus according to claim 5, wherein said mesh element number reduction unit does not reduce said mesh elements in a portion designated not to be reduced relative to said message, and said mesh fine division unit performs mesh fine division.

9. The analyzing mesh generating apparatus according to claim 1, wherein said mesh element number reduction unit reduces said mesh elements in a portion designated to be reduced relative to said message.

10. The analyzing mesh generating apparatus according to claim 5, wherein said mesh element number reduction unit determines whether said mesh elements corresponding to said characteristic shape including shapes of the steps, projections, holes and grooves are to be reduced, in accordance with interactive designation responding to an image displayed on said display unit.
